(19) United States
(12) Patent Application Publication
(10) Pub. No.: US 2026/0152123 A1
(43) Pub. Date: Jun. 4, 2026

(54) IMAGE PLANE DEGRADATION DETECTION

(71) Applicant: QUALCOMM Incorporated, San Diego, CA (US)

(72) Inventors: Axel EK, Linköping (SE); Anisse TALEB, Nykil (SE); David Oskar Peter FORSLUND, Linköping (SE)

(21) Appl. No.: 18/968,999

(22) Filed: Dec. 4, 2024

(51) Int. Cl. B60R 1/22

(52) U.S. Cl. CPC B60R 1/22; B60R 2300/102; B60R 2300/105; B60R 2300/301; B60R 2300/303; B60R 2300/307; B60R 2300/607

(57) ABSTRACT

Certain aspects of the present disclosure provide techniques for assessing sensor performance. The method includes obtaining a BEV representation of an environment comprising encoded features of the environment; obtaining, from one or more sensors, an image of a portion of the environment; generating, with an inverse view transform applied to the BEV representation, an image plane representation comprising one or more of the encoded features that are associated with the portion of the environment from the BEV representation; fusing, through a feature fusion process, a set of features represented in the image of the portion of the environment with the one or more encoded features of the image plane representation; and identifying a region of degradation within the image based on one or more features in the image plane representation predicted to be deteriorated.

### INTRODUCTION

### Field of the Disclosure

Aspects of the present disclosure relate to sensor performance assessment techniques.

### Description of Related Art

Sensors are vital in apparatuses, such as autonomous vehicles, robotic systems, and the like. Sensors enable perception of an environment, which may be useful for localization for path planning, decision making and numerous other operations. Numerous sensors, such as vision sensors, radar sensors, LiDAR systems, ultrasonic sensors, and the like can be utilized to sense the environment around an apparatus. The continuous and reliable performance of the sensors may be essential to the operation of the apparatus.

Accordingly, there is a need for techniques to assess the performance of sensors during implementation so the sensors may provide continuous and reliable performance.

### SUMMARY

One aspect provides a method for sensor performance assessment by an apparatus or a processing system. The method includes obtaining a BEV representation of an environment comprising encoded features of the environment; obtaining, from one or more sensors, an image of a portion of the environment; generating, with an inverse view transform applied to the BEV representation, an image plane representation comprising one or more of the encoded features that are associated with the portion of the environment from the BEV representation; fusing, through a feature fusion process, a set of features represented in the image of the portion of the environment with the one or more encoded features of the image plane representation; and identifying a region of degradation within the image based on one or more features in the image plane representation predicted to be deteriorated.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative environment of a road scene.

FIG. 2 depicts an illustrative sensor and computing system equipped apparatus, such as a vehicle.

FIG. 3 depicts an illustrative block diagram of an architecture for assessing sensor performance.

FIG. 4A depicts a first visual representation of an illustrative inverse view transform.

FIG. 4B depicts a second visual representation of the illustrative inverse view transform.

FIG. 4C depicts a third visual representation of the illustrative inverse view transform.

FIG. 4D depicts a fourth visual representation of the illustrative inverse view transform.

FIG. 5 depicts aspects of an example method.

FIG. 6 depicts aspects of an example apparatus for performing the sensor performance assessment techniques.

### DETAILED DESCRIPTION

Aspects of the present disclosure provide apparatuses, methods, processing systems, and computer-readable mediums for assessing sensor performance. For purposes of describing aspects of the sensor performance assessment techniques, the apparatus discussed herein will be an autonomous vehicle equipped with one or more sensors including cameras configured to capture image data of an environment and support advanced driving systems of a vehicle, such as semi-autonomous or autonomous vehicle systems with the image data. However, this is merely one example implementation as the apparatus may be a robotic system, an aircraft, a marine vessel, or the like, and the one or more sensors may be any suitable sensor(s).

In certain aspects, the sensors may be image sensors, such as one or more cameras. The sensors may be positioned on the vehicle. The sensors may have distinct or partially overlapping fields of view so that the sensors can capture image data of an environment around the apparatus. The image data captured by the sensors may be utilized by advanced driving systems of the vehicle for operations, such as navigation systems, perception systems, collision avoidance systems, manipulation systems, and the like.

However, there are situations where the performance of the sensors are negatively impacted by factors in the environment and/or issues with the functionality of the sensors themselves, such as damage to a lens, bad calibration, or the like. Situations where the performance of the sensors is negatively impacted may be determined through an assessment of the data captured by the sensors. For example, the image data captured by the one or more cameras may present as a degradation such as a blockage, glare, or the like within the image data.

Degradation present in image data can negatively impact the functionality of advanced driving systems of the vehicle. For example, a degradation within the image data manifesting as a blockage or a glare, for example, may deteriorate features in the environment such that the advanced driving systems of the vehicle are unable to accurately discern information about the environment from the image data and in some cases fail to properly function.

Some current systems attempt to address issues of degradation within sensor data, such as image data, by assessing sensors independently. However, this method is not aware of spatial (e.g., three-dimensional) information and thus can create inconsistencies in the detections of degradation. That is, current systems analyze each sensor independently without any information about the environment such as spatial awareness provided by other sensors. Additionally, current systems may only assess the data collected by the sensor being assessed and therefore do not have a comparative sample to assess the data against.

Aspects of the sensor performance assessment techniques provide a number of technical improvements over the current systems and methods. In certain aspects, the sensor performance assessment techniques leverage information from a bird's eye view (BEV) representation of the environment. The BEV representation of the environment refers to a top-down view of the environment. The BEV representation may be made up of image data, spatial information such as location information corresponding to pixels or features in the image data, and feature information. The information represented in the BEV representation may include encoded features that are associated with features in the environment. Encoded features may refer to the numerical representation of categorical values of relevant features. The features may be aspects of an object such as a corner, an edge, or other structure that may be invariant to rotation, translation, and illumination. Through inverse view transform processes, which are described in more detail herein, an image plane representation that corresponds to a field of view of image data from the sensor can be generated from the BEV representation of the environment. A feature fusion process may be applied to the image plane representation and the image data such that the encoded features in the image plane representation and a set of features in the image data may be fused. For example, the encoded features in the image plane representation may be the numerical representation of visual features including, but not limited to a corner, an edge, or other structure that was transformed from the BEV representation into the image plane representation. The set of features may similarly be the numerical representation of visual features perceived by sensors that correspond to, but are not limited to, corners, edges, or other structures that may be invariant to rotation, translation, and illumination. As a result of fusing the encoded features in the image plane representation and the set of features in the image data a fused feature set representing both the encoded features and the set of features in a fused representation may be generated. The fused representation may be an image based representation of the environment of the image data and the image plane representation and the feature information from each of the respective sources.

The fused representation may then be utilized to identify a region of degradation within the image where one or more features corresponding to a feature from the encoded features of the image plane representation presents as a deteriorated feature from the set of features of the image data. As used herein, the term “deteriorated” may refer to image distortion (such as warping or twisting), issues with clarity (such as instances of glare, debris on a lens of the camera, or blockages), and/or other imperfections manifesting in a loss of quality, clarity, color, light, or other information within an image. Thus, “deterioration” may include and may not be limited to instances of image distortion. A feature-to-feature comparison may be utilized to determine which of the one or more features of the encoded features from the image plane representation has a corresponding feature in the set of features from the image data that presents in a deteriorated manner. More specifically, an edge feature in the encoded features and the corresponding edge feature form the set of features may be fused into the fused representation and compared to determine whether the corresponding edge feature from the set of feature is presenting in a deteriorated manner. Presentation of the corresponding edge feature in a deteriorated manner can provide indication that the image data at or around the location of the corresponding edge feature is a region of degradation.

The sensor performance assessment techniques disclosed herein can be applied to either overlapping and non-overlapping multi-sensor domains because assessment of the sensor data may be made with reference to the encoded features inversely transformed from the BEV representation of the environment into a plane corresponding to the field of view represented by the image captured by the sensor (e.g., camera).

In addition to providing a technical improvement over current systems of detecting a degradation in sensor data, such as image data, by creating a comparative feature set through an inverse view transform of the BEV representation of the environment, the sensor performance assessment techniques may also leverage shared computation resources of the embedded system. Embedded systems, such as those implemented for advanced driving systems may have limited computation resources. The sensor performance assessment techniques can leverage shared computation resources in a multi-task setting to improve performance of image degradation detection instead of requiring function specific computation resources. For example, the heads for image degradation detections do not need to be the same heads used for forming the BEV representation.

A “head” is the top of a network, such as a neural network including a convolutional neural network or other type of network. The bottom of a network is where data is input, for example, to a set of convolution layers. By interchanging the head of a network, a model can take inputs from the base network (e.g., one or more layers of a network of or near the input of the network) and feed the activations to the top of the network (e.g., a stage before the output of the network) where the activations are input into one or more heads, which may be similar or different types of heads. Activations of a network refer to the one or more neurons of the network that are activated (e.g., important to the process). In this way, computation resources required for the base network can be shared between two or more different heads configured to generate different predictions.

Since a first head for image degradation detection and a second head for forming the BEV representation may utilize the same base network, the computation resources may be shared and thereby minimize or eliminate the need for the limited computation resources of the embedded system to be expanded for implementing sensor performance assessment techniques described herein.

### BEV Perception of an Environment

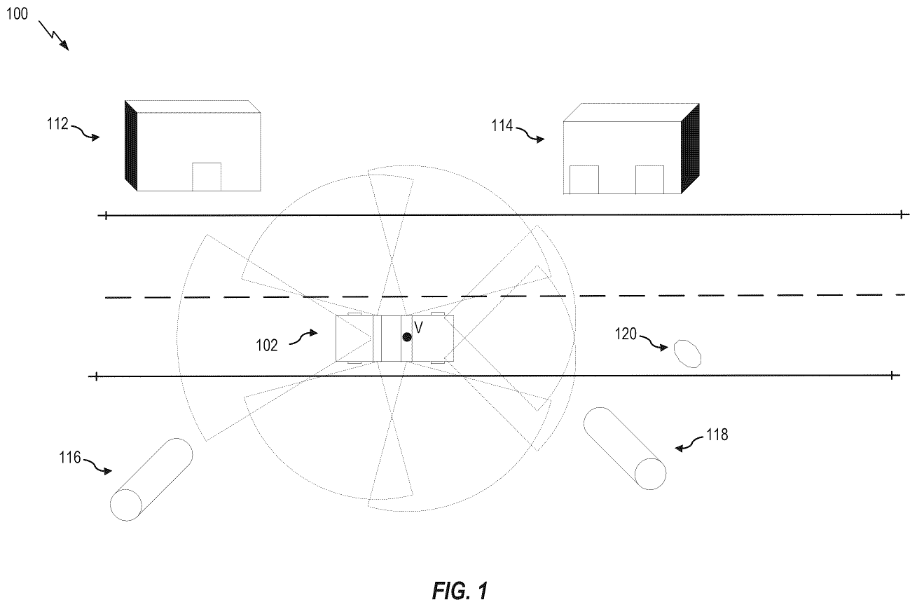

FIG. 1 depicts an illustrative environment 100 of a road scene. The road scene includes a vehicle 102 equipped with a plurality of sensors, optionally having different modalities, that are fused together following techniques described herein to generate a BEV perception of the environment. In certain aspects (not shown), the vehicle 102 may be equipped with one or more of the same type of sensor and different projections from the same one or more sensors may be fused together to generate a BEV perception of the environment. The BEV perception, which may be single or multi-modal, of the environment include encoded features corresponding to features in the environment such as structures 112, 114, signs or poles 116, 118, potholes 120, and/or other features not specifically depicted in FIG. 1. Features in the environment may be physical objects or component of objects such as corners, edges, or other structures or shapes that may be invariant to rotation, translation, and illumination. The encoding of those features, which is referred to as encoded features, refers to the numerical representation of the feature. The plurality of sensors may each have a corresponding field of view illustratively depicted by the dashed lined fields.

Certain aspects described herein may utilize not only the view point of the sensor with reference to their field of view to search for features, but also adjust the azimuth perspective angle of the sensor data to extract additional and richer feature information about the environment. For example, the nominal viewpoint of a camera defines its field of view. However, the image data captured by the camera can be viewed from different azimuth perspective angles and/or different angles of elevation, which are different from the nominal viewpoint of the camera in order to obtain different perspectives and potentially information about features, for example, contributing to small objects or occluded space. Certain aspects described herein provide techniques for combining multi-azimuth viewpoints of the sensor data to generate more feature rich and dense BEV planes corresponding to environments of the vehicle 102.

It should be understood that while the illustrative example discussed herein include a vehicle 102 traversing a road environment, the techniques described herein may be implemented on various apparatuses such as a robot operating in a facility or other environment. Additionally, in certain aspects, the techniques described herein may be implemented on one or more various apparatuses separate from apparatus configured with sensors to collect perception sensor data of the environment. For example, the vehicle 102 may be a terrestrial vehicle such as an automobile, a truck, a motorcycle, a bicycle, a robotic device, or the like; an amphibious vehicle, such as a boat, a sailboat, a ship, a submarine, an unmanned amphibious vehicle, or the like; or an aerial vehicle such as a helicopter, a quadcopter, an unmanned aerial vehicle or the like.

Given the road scene depicted in FIG. 1, specific aspects will be described herein.

### Sensor and Computing System Equipped Apparatus

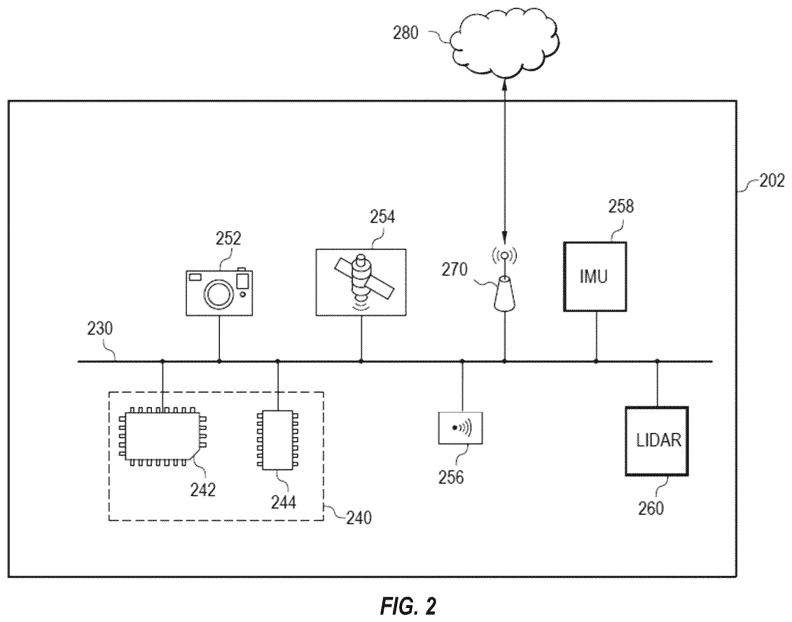

FIG. 2 depicts an illustrative sensor and computing system equipped apparatus, such as an autonomous vehicle (AV) corresponding to aspects described herein. The apparatus 202 may be an example of the vehicle 102 depicted in FIG. 1 or other apparatus such as a robot. The apparatus 202 depicted in FIG. 2 is depicted by way of an example schematic of a vehicle including sensor resources and a computing device. Not every vehicle is required to be equipped with the same set of sensor resources, nor is every vehicle required to be configured with the same set of systems for perceiving attributes of an environment. FIG. 2 only provides one example configuration of sensor resources and systems equipped within a vehicle.

In particular, FIG. 2 provides an example schematic of apparatus 202 including a variety of sensor resources, which may be utilized by the apparatus 202 to perceive and collect sensor data about the environment. For example, the apparatus 202 may include a computing device 240 comprising one or more processors 242 and a non-transitory computer readable memory 244 (also referred to herein as one or more memories), one or more cameras 252, a global positioning system (GPS) 254, a radar system 256, an IMU 258, a LiDAR system 260, and network interface hardware 270. The aforementioned components of the apparatus are merely examples as some apparatuses may have more or less components and/or different sensors for perceiving the environment. These and other components of the apparatus 202 may be communicatively connected to each other via a communication path 230. It should be noted that non-transitory computer readable memory 244 may include volatile and/or non-volatile memory or storage.

The communication path 230 may be formed from any medium that is capable of transmitting a signal such as, for example, conductive wires, conductive traces, optical waveguides, or the like. The communication path 230 may also refer to the expanse in which electromagnetic radiation and their corresponding electromagnetic waves traverse. Moreover, the communication path 230 may be formed from a combination of mediums capable of transmitting signals. In some aspects, the communication path 230 comprises a combination of conductive traces, conductive wires, connectors, and buses that cooperate to permit the transmission of electrical data signals to components such as processors, memories, sensors, input devices, output devices, and communication devices. Accordingly, the communication path 230 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 240 may be any device or combination of components comprising one or more processors 242 and non-transitory computer readable memory, referred to herein as one or more memories 244. The one or more processors 242 may be any device capable of executing the processor-executable instructions stored in the one or more memories 244. Accordingly, the one or more processors 242 may be an electric controller, an integrated circuit, a microchip, a computer, or any other computing device. The one or more processors 242 are communicatively coupled to the other components of the apparatus 202 by the communication path 230. Accordingly, the communication path 230 may communicatively couple any number of processors 242 with one another, and allow the components coupled to the communication path 230 to operate in a distributed computing environment. Specifically, each of the components may operate as a node that may send and/or receive data.

The one or more memories 244 may comprise RAM, ROM, flash memories, hard drives, or any non-transitory memory device capable of storing processor-executable instructions such that the processor-executable instructions can be accessed and executed by the one or more processors 242. The machine-readable instruction set may comprise logic or algorithm(s) written in any programming language of any generation (e.g., 1 GL, 2 GL, 3 GL, 4 GL, or 5 GL) such as, for example, machine language that may be directly executed by the one or more processors 242, or assembly language, object-oriented programming (OOP), scripting languages, microcode, etc., that may be compiled or assembled into processor-executable instructions and stored in the one or more memories 244. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The apparatus 202 may further include one or more cameras 252. The one or more cameras 252 may be any device having an array of sensing devices (e.g., a CCD array or active pixel sensors) capable of detecting radiation in an ultraviolet wavelength band, a visible light wavelength band, or an infrared wavelength band. The one or more cameras 252 may have any resolution. The one or more cameras 252 may be an omni-direction camera or a panoramic camera. In some aspects, one or more optical components, such as a mirror, fish-eye lens, or any other type of lens may be optically coupled to the one or more cameras 252. The image data collected by the one or more cameras 252 may be stored in the one or more memories 244.

Still referring to FIG. 2, a global positioning system, GPS 254, may be coupled to the communication path 230 and communicatively coupled to the computing device 240 of the apparatus 202. The GPS 254 is capable of generating location information indicative of a location of the apparatus 202 by receiving one or more GPS signals from one or more GPS satellites. The GPS signal communicated to the computing device 240 via the communication path 230 may include location information comprising a National Marine Electronics Association (NMEA) message, a latitude and longitude data set, a street address, a name of a known location based on a location database, or the like. Additionally, the GPS 254 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 254 may be stored in the one or more memories 244.

The apparatus 202 may also include a radar system 256. The radar system 256 measures the distance to objects over wide distances. It is also possible to measure the relative speed of the detected object. The radar system 256 may be a continuous wave (CW), frequency-modulated continuous wave (FMCW), 3D-radar (3D FMCW multiple-input and multiple-output (MIMO)), or 4D-radar (4D FMCW MIMO). The sensor data collected by the radar system 256 may be stored in the one or more memories 244.

The apparatus 202 may include an inertial measurement unit (IMU) 258. The IMU 258 is an electronic device that measures and reports an apparatus's specific force, angular rate, and sometimes the orientation of the apparatus, using a combination of accelerometers, gyroscopes, and sometimes magnetometers. The sensor data collected by the IMU 258 may be stored in the one or more memories 244.

In some aspects, the apparatus 202 may include a LiDAR system 260. The LiDAR system 260 is communicatively coupled to the communication path 230 and the computing device 240. A LiDAR system 260 or light detection and ranging is a system and method of using pulsed laser light to measure distances from the LiDAR system 260 to objects that reflect the pulsed laser light. A LiDAR system 260 may be made as solid-state devices with few or no moving parts, including those configured as optical phased array devices where its prism-like operation permits a wide field-of-view without the weight and size complexities associated with a traditional rotating LiDAR system 260. The LiDAR system 260 is particularly suited to measuring time-of-flight, which in turn can be correlated to distance measurements with objects that are within a field-of-view of the LiDAR system 260. By calculating the difference in return time of the various wavelengths of the pulsed laser light emitted by the LiDAR system 260, a digital 3-D representation of a target or environment may be generated. The pulsed laser light emitted by the LiDAR system 260 includes emissions operated in or near the infrared range of the electromagnetic spectrum, for example, having emitted radiation of about 905 nanometers. Sensors such as the LiDAR system 260 can be used by vehicles to provide detailed 3D spatial information for the identification of objects near the apparatus 202, as well as the use of such information in the service of systems for vehicular mapping, navigation and autonomous operations, especially when used in conjunction with geo-referencing devices such as GPS 254 or a gyroscope-based inertial navigation unit (INU, not shown or IMU 258) or related dead-reckoning system. The point cloud data collected by the LiDAR system 260 may be stored in the one or more memories 244.

Still referring to FIG. 2, apparatuses, such as vehicles are now more commonly equipped with communication systems, such as vehicle-to-vehicle communication systems. Some of the systems rely on network interface hardware 270. The network interface hardware 270 may be coupled to the communication path 230 and communicatively coupled to the computing device 240. The network interface hardware 270 may be any device capable of transmitting and/or receiving data with a network 280 or directly with another vehicle, such as equipped with a vehicle-to-vehicle communication system. Accordingly, network interface hardware 270 can include a communication transceiver for sending and/or receiving any wired or wireless communication. For example, the network interface hardware 270 may include an antenna, a modem, LAN port, Wi-Fi card, WiMax card, mobile communications hardware, near-field communication hardware, satellite communication hardware and/or any wired or wireless hardware for communicating with other networks and/or devices. In some aspects, network interface hardware 270 includes hardware configured to operate in accordance with the Bluetooth wireless communication protocol. In some aspects, network interface hardware 270 may include a Bluetooth send/receive module for sending and receiving Bluetooth communications to/from a network 280 and/or another vehicle.

### Aspects Related to Sensor Performance Assessment

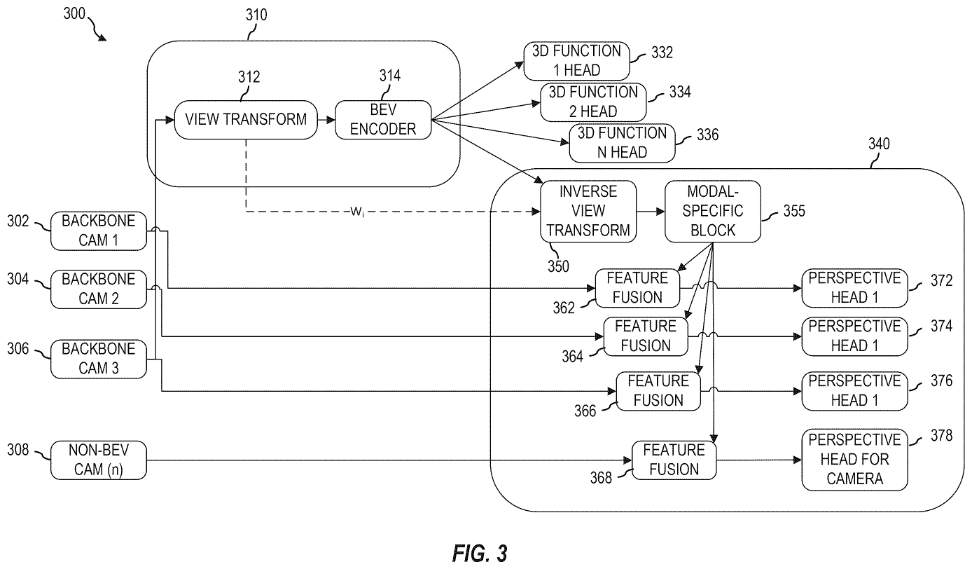

FIG. 3 depicts an illustrative block diagram of an architecture 300 for assessing sensor performance. The architecture 300 may be implemented as software and/or hardware, such as the computing device 240 comprising one or more processors 242 and a non-transitory computer readable memory 244 shown for example in FIG. 2. The architecture 300 includes several components which will be described herein. The architecture 300 includes two general components: a BEV representation portion 310 and a sensor performance assessment portion 340. The BEV representation portion 310 is configured to generate the BEV representation of an environment. It is understood that the BEV representation portion 310 is one example process for generating the BEV representation. The sensor performance assessment portion 340, as described in more detail herein, may be implemented with the BEV representation portion 310 or independently whereby the sensor performance assessment portion 340 may be configured to obtain a BEV representation of the environment generated by another method or architecture than described herein.

In certain aspects, a first vehicle (e.g., an ego-vehicle) may be equipped with one or more sensors, such as one or more cameras 302, 304, 306 configured to obtain image data of the environment the vehicle traverses. The first vehicle may be configured to generate the BEV representation of the environment based on the image data and, optionally, sensor data from one or more other sensor modalities, such as LiDAR systems or the like.

In some aspects, a second vehicle may capture sensor data with the one or more sensors, such as the one or more cameras 302, 304, 306, to generate the BEV representation of the environment. The second vehicle may then provide the BEV representation to the first vehicle or one or more other vehicles. As described herein the BEV representation, whether generated by the ego-vehicle or not, may be used by the sensor performance assessment portion 340 to assess the performance of the one or more sensors of the ego-vehicle.

In certain aspects, the images captured for generating the BEV representation may be obtained as a temporal series of images. In some aspects, the temporal series of images include cross-camera features from multiple time-steps. Cross-camera features may refer to one or more features captured by one or more cameras and tracked between the one or more cameras and optionally through time. For example, a feature associated with a vehicle may be captured in image data of a first camera at a first time and then the vehicle may be captured in image data of a second camera at a second time, whereby the feature of the vehicle can be tracked between cameras and over time.

In certain aspects, the temporal series of images can be leveraged as an extra feature vector to input in the feature fusion process, as described further herein. Additionally, the temporal series of images can provide the sensor performance assessment spatial and temporal knowledge as to the existence and location of features seen at an earlier time. For example, the temporal series of images may include image data corresponding to the sun or an object such as a signpost, and through temporal or cross-camera feature tracking of the respective objects, the placement of the sun or a signpost may be determined. Additionally, ego motion (e.g., movement of the vehicle through the environment) and temporal series of images can provide an understanding of the trajectory of the vehicle and where the objects are located in the BEV representation. In certain aspects where a temporal series of images may be used to generate the BEV representation of the environment, there may not be a need for overlapping fields of view to generate the BEV representation. For example, features from an image at a first time may be associated with features from an image at a second time to generate the BEV representation, but the fields of view for the image at the first time and the image at the second time may not overlap. In certain aspects, leveraging static or near static objects in the environment that are detected by a sensor, the movement of the sensor or corresponding vehicle comprising the sensor can be coordinated so that the field of view of at least one sensor covers the view of an object in the environment.

Whether the BEV representation portion 310 is implemented by the first vehicle, the second vehicle, or another computing platform, in certain aspects, the BEV representation portion 310 generally includes at least a view transform block 312 and a BEV encoder block 314. In certain aspects, the BEV representation portion 310 may implement BEVFormer that generates BEV features (e.g., BEV feature maps defining features and their corresponding location and/or dimensions) using spatiotemporal transformers. In certain aspects, the BEV representation portion 310 may utilize a Lift-Splat approach, a deformable attention network (e.g., as implemented in BEVFormer), bilinear sampling, or other techniques. The one or more BEV feature maps may be infused with metric information such as depth information collected by a LiDAR system, a radar system or other depth perceiving sensor system. The infusion of metric information may enable depth supervision with respect to projecting features from the one or more BEV feature maps into 3D feature volumes. The resulting 3D feature volumes are then collapsed onto the BEV plane, for example, using a differentiable BEV projection layer. In certain aspects, a differentiable BEV projection layer discretizes the 3D space (e.g., 3D feature volumes) into BEV cells and aggregates features from the relevant BEV cells (e.g., 3D voxels).

In some aspects, the view transform block 312 receives image data and/or other sensor data, such as a point cloud and/or depth data from the one or more sensors configured to perceive the environment. The view transform block 312 may be one of a variety of models or processes configured to lift image features from 2D image data and place them in a BEV plane. In some instances, the features may be weighted based on depth, which can improve the projection of the features into the BEV plane. For example, features in the image data may be projected on the BEV plane (e.g., within a BEV space) by estimating the depth value of each pixel in the image using the camera calibration parameters to determine the corresponding position of each pixel in the 3D space.

The BEV encoder block 314 may be BEVFormer, which may include a number of (e.g., six (6)) encoder layers, each designed based on a transformer architecture with specific modifications for BEV generation. The BEV encoder block 314 may effectively aggregate spatiotemporal features from multi-view cameras and historical BEV features. Historical BEV features are BEV features from prior points in time. The BEVFormer may include components such as BEV queries, spatial cross-attention, and temporal self-attention components. BEV queries may be grid-shaped, learnable parameters that query BEV plane features from multi-camera views. The spatial cross-attention is the view transformation module that lifts perspective image features into BEV features. The temporal self-attention may incorporate temporal information into the BEV plane by interacting with two features: the BEV queries at the current timestamp and the BEV features at the previous timestamp.

In certain aspects, one or more heads 332, 334, 336 may be attached to the BEV representation portion 310. The one or more heads 332, 334, 336 may include a 3D detection head that predicts 3D bounding boxes and object classes from the BEV representation generated by the BEV representation portion 310. The one or more heads 332, 334, 336 may be task-specific heads such as those for 3D object detection and map segmentation. The one or more heads 332, 334, 336 may be perception heads that are configured to support driving perception tasks associated with 3D object detection and map segmentation.

As discussed herein, systems, such as the advanced driving systems of a vehicle, depend on reliable and continuous sensor data that is generally degradation free to provide operations of the advanced driving systems. The sensor performance assessment portion 340 provides the systems, such as the advanced driving systems, with the ability to assess whether sensor data, such as image data includes a deterioration. A region of degradation may manifest as a deterioration including but not limited to, for example, a blockage, a glare, a blur, or other imperfections manifesting in a loss of quality, clarity, color, or other information within the image perceived by the one or more sensors. For example, the degradation may cause the advanced driving systems of the vehicle to inaccurately discern information about the environment from the image data and in some cases fail to properly function.

The sensor performance assessment portion 340 may obtain the BEV representation of the environment that the apparatus, for example, the autonomous vehicle, is traversing. The BEV representation of the environment may be obtained from one or more memories of the computing system onboard the vehicle. In certain aspects, the BEV representation of the environment may be received through a communication link with another vehicle or an off-board computing device. That is, the vehicle does not need to have generated the BEV representation with local sensor resources, for example, one or more cameras 302, 304, 306.

The sensor performance assessment portion 340 may also obtain image data of the environment from at least one of the one or more cameras 302, 304, 306, 308. The one or more cameras 302, 304, 306, 308 may be a camera that contributed to the generation of the BEV representation, for example, one of cameras 302, 304, or 306 and/or one or more cameras 308 that did not contribute to the generation of the BEV representation.

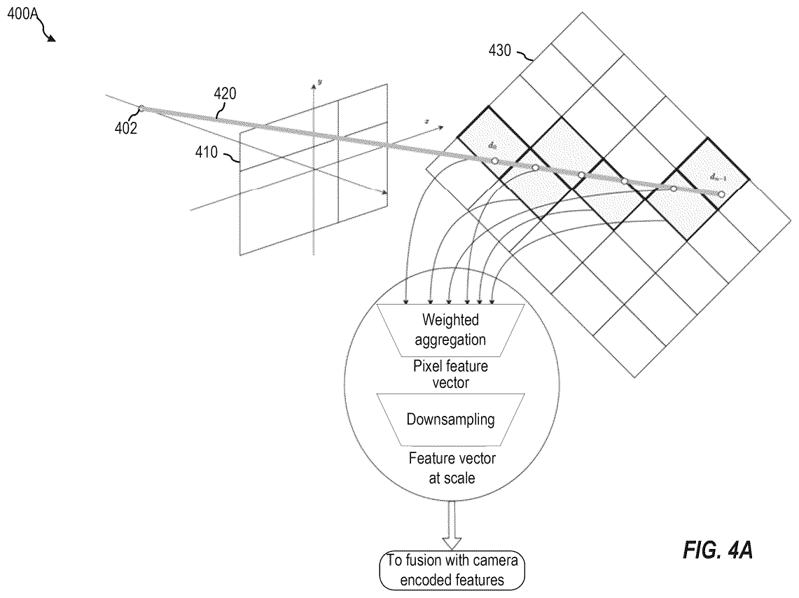

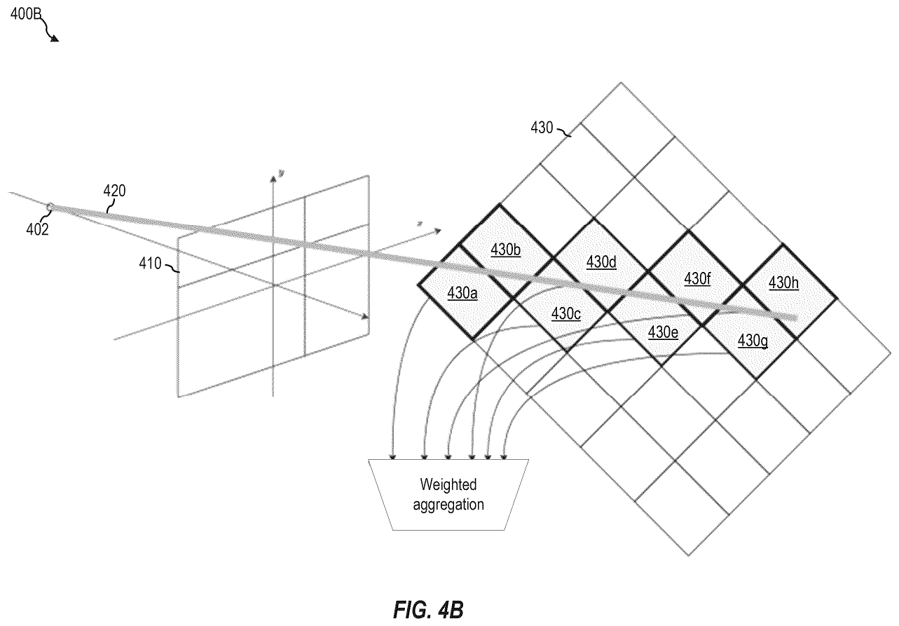

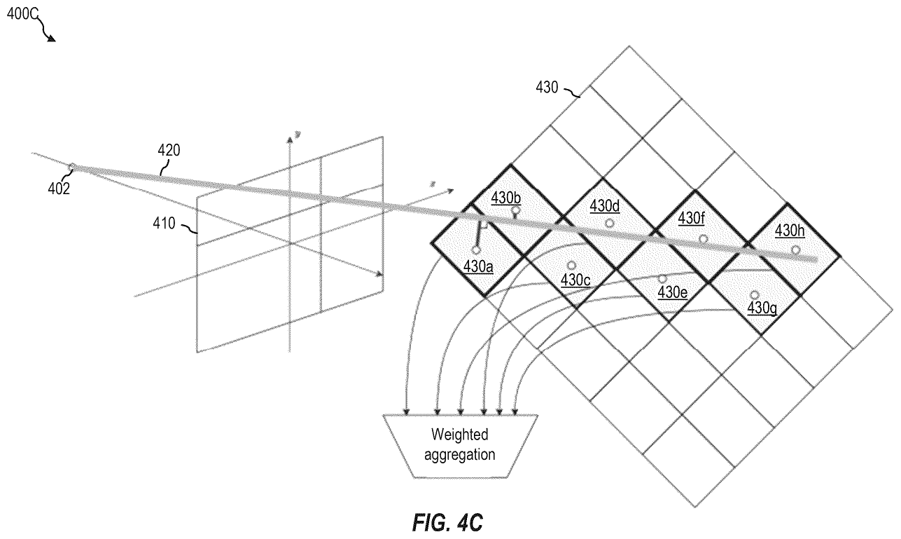

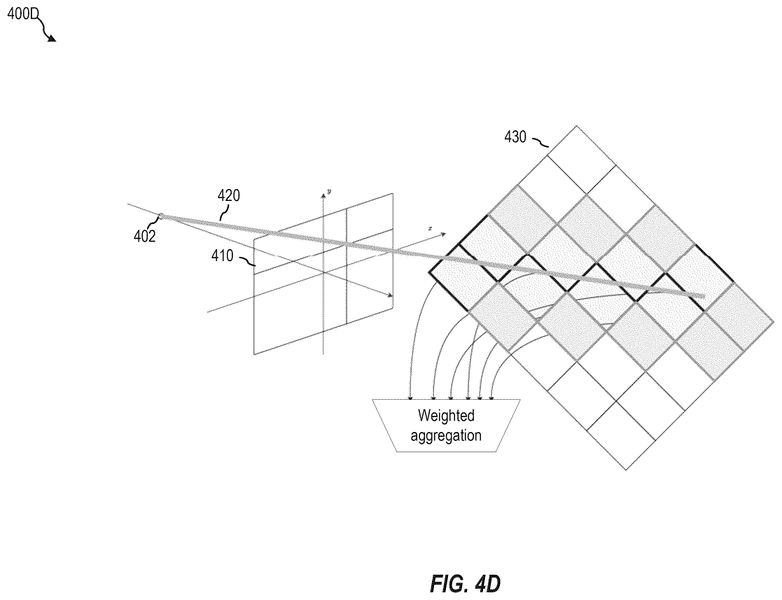

The sensor performance assessment portion 340 includes an inverse view transform block 350. The inverse view transform block 350 generates an image plane representation of the environment from the BEV representation of the environment. In general, the inverse view transform block 350 reverses the view transform process where image data in image planes are transformed into a BEV representation. That is, the inverse view transform block 350 can generate an image plane representation that correspond to a field of view or at least partially overlaps a field of view of at least one of the one or more cameras 302, 304, 306, 308. In some such instances, the weights Wᵢ utilized in the view transform block 312 may be provided to and utilized by the inverse view transform block 350. In certain aspects, the plane of the image plane representation may be determined based on the field of view of a camera, a position of the camera, an orientation of the camera, a resolution of the camera, and/or the other aspects of the camera. The image plane representation generated from the BEV representation comprises encoded features, such as numerical representations of corners, edges, or other shapes and structures that may be invariant to rotations, translation, or illumination changes. The encoded features are associated with the portion of the environment encoded in the BEV representation. Illustrative examples of example processes implemented by the inverse view transform block 350 are discussed with reference to FIGS. 4A to 4D.

By generating an image plane representation with encoded features, a feature fusion process may be carried out to fuse a set of features, such as numerical representations of corners, edges, or other shapes and structures that may be invariant to rotations, translation, or illumination changes, present in the image data captured by the at least one of the one or more cameras 302, 304, 306, 308 with the encoded features of the image plane representation. In some aspects, the image plane representation generated by the inverse view transform block 350 may feed through a modal-specific block 355. The modal-specific block 355 may include a modal specific network having one or more Res-Net bottlenecks and/or SWIN-transformer blocks which operate to improve the fusion between modalities, such as image data and depth data. However, the modal-specific block 355 is an optional component of the sensor performance assessment portion 340.

The sensor performance assessment portion 340 further includes one or more feature fusion blocks 362, 364, 366, or 368. The one or more feature fusion blocks 362, 364, 366, or 368, respectively receive the image from the one or more cameras 302, 304, 306, 308. The one or more feature fusion blocks 362, 364, 366, or 368 also receive a respective image plane representation that corresponds to the field of view of the one or more cameras 302, 304, 306, and 308. The one or more feature fusion blocks 362, 364, 366, or 368 fuse (e.g., merge) the set of features represented in the image of the portion of the environment with the one or more encoded features of the image plane representation. In certain aspects, the one or more feature fusion blocks 362, 364, 366, or 368 may perform a feature-wise concatenation to fuse the set of feature of the image with the one or more encoded features of the image plane representation. In certain aspects, the one or more feature fusion blocks 362, 364, 366, or 368 may execute a cross-attention process to fuse the set of feature of the image with the one or more encoded features of the image plane representation. In certain aspects, the one or more feature fusion blocks 362, 364, 366, or 368 may execute an element-wise addition process or an element-wise product process to fuse the set of feature of the image with the one or more encoded features of the image plane representation. For example, the element-wise product process, may be a Hadamard product, which is a mathematical operation that multiplies the corresponding elements of two matrices or vectors to produce a new matrix or vector of the same dimensions. The two matrices may be the set of features represented in the image of the portion of the environment and the one or more encoded features of the image plane representation. Other methods of feature fusion may also be implemented by the one or more feature fusion blocks 362, 364, 366, or 368, for example, including but not limited to a weighted or element-wise summation.

The fused features may then be used to identify a region of degradation within the image, should degradation be present. Identification of the region of degradation within the image may be based on the presence of one or more features corresponding to a feature from the encoded features of the image plane representation presents as a deteriorated feature from the set of features of the image data. For example, a feature-to-feature comparison may be utilized to predict with a level of certainty which of the one or more features of the encoded features from the image plane representation has a corresponding feature in the set of features from the image data that presents in a deteriorated manner. A prediction of deterioration may be determined by one or more heads of a neural network configured to predict, from the fusion of the set of features represented in the image of the portion of the environment and the one or more encoded features of the image plane representation, one or more regions of degradation. The prediction may indicate degradation in the region of the image (that is, the region of the image or the one or more features in the region may be predicted to be deteriorated) when the prediction meets or exceeds a level of certainty, where the level of certainty may be a predefined value or learned over time. For example, an edge feature in the encoded features and the corresponding edge feature form the set of features may be fused into the fused representation and compared to determine whether the corresponding edge feature from the set of feature is presenting in a deteriorated manner. Presentation of the corresponding edge feature in a deteriorated manner can provide indication that the image data at or around the location of the corresponding edge feature is a region of degradation. The feature that is deteriorated may present itself as being blocked, occluded from view, having a glare, a blur, or other imperfection manifesting in a loss of quality, clarity, color, or other information within the image.

In certain aspects, when a region of an image captured by the one or more cameras 302, 304, 306, and 308 is identified as having a degradation, one or more actions may be implemented to ensure the utilization of that image does not interfere with the operation of a system, such as an advanced driving system. For example, the sensor and/or the image may be removed from use until the degradation is addressed. One or more other images having an overlapping field of view that corresponds to the region of degradation may be utilized in place of the region of degradation. In some instances, an alert or warning may be generated to provide a user or the system with an indication that there is a degradation in image data that may need to be corrected. These are only a few measures that may be taken in response to identifying a region of degradation within an image captured by the one or more cameras 302, 304, 306, and 308.

### Aspects Related to Inverse View Transform

FIGS. 4A to 4D depict illustrative examples of processes implemented by the inverse view transform block 350 to generate the image plane representation of the environment. FIG. 4A depicts a first visual representation 400A of an illustrative inverse view transform. The inverse view transform generates an image plane representation from the perspective of the position 402 and field of view 410 of the respective camera (e.g., one of the one or more cameras 302, 304, 306, 308). A plurality of camera rays 420 extending from the position 402 through respective pixels of the field of view 410 of the camera to the BEV plane 430 define portions of the BEV plane 430 where sampling of features from the encoded features in the BEV plane 430 should occur. As illustrated in the first visual representation 400A, points d₀ to dₙ₋₁ that intersect a respective camera ray of the plurality of camera rays 420 within the BEV plane 430 are sampled from the BEV plane 430. The sampling scheme applied may include sampling at discrete distance intervals along the respective camera ray. For example, each of the points d₀ to dₙ₋₁ are spaced at discrete intervals (e.g., uniformly spaced apart) along the respective camera ray of the plurality of camera rays 420. A weight aggregator may receive BEV information for each of the sampled points d₀ to dₙ₋₁. The weighted aggregator may be an average of the sample points of the BEV space. The weight aggregation may be expressed by

$${\sum }_{i} {w}_{i} {H}_{i}^{bev} ,$$

where i is the sampled points d₀ to dₙ₋₁, w may be the weight value(s) utilized in the view transform block 312 and may be provided to and utilized by the inverse view transform block 350, and H is the information sampled from the BEV plane corresponding to each of the sampled points. For example, instances where the weight value(s) from the view transform block 312 are reused by the inverse view transform may provide a more efficient use of computation and memory resources than instances where new weight value(s) for the inverse view transform process are generated and utilized. The inverse view transform may be obtained by aggregating the 3D features corresponding to the sample points d₀ to dₙ₋₁ from the ray extending through each feature using a pre-learned depth distribution as a weight vector in the aggregation.

FIG. 4B depicts a second visual representation 400B of an illustrative inverse view transform. Similar to the inverse view transform discussed with reference to FIG. 4A, the inverse view transform of FIG. 4B generates an image plane representation from the perspective of the position 402 and field of view 410 of the respective camera (e.g., one of the one or more cameras 302, 304, 306, 308). A plurality of camera rays 420 extending from the position 402 through respective pixels of the field of view 410 of the camera to the BEV plane 430 define portions of the BEV plane 430 where sampling of features from the encoded features in the BEV plane 430 should occur. As illustrated in the second visual representation 400B, the sampling scheme applied may be a uniform sampling distribution along the respective camera ray. The sampling scheme obtains information from the cells 430a-430h of the BEV plane that the respective camera ray of the plurality of camera rays 420. The obtained information may be aggregated using a weighted aggregator in a similar manner as described with reference to FIG. 4A.

FIG. 4C depicts a third visual representation 400C of an illustrative inverse view transform. Similar to the inverse view transform discussed with reference to FIG. 4A, the inverse view transform of FIG. 4C generates an image plane representation from the perspective of the position 402 and field of view 410 of the respective camera (e.g., one of the one or more cameras 302, 304, 306, 308). A plurality of camera rays 420 extending from the position 402 through respective pixels of the field of view 410 of the camera to the BEV plane 430 define portions of the BEV plane 430 where sampling of features from the encoded features in the BEV plane 430 should occur. As illustrated in the third visual representation 400C, the sampling scheme applied may be a sampling weighted by orthogonal distance from a center point of a grid coordinate of the BEV plane 430 to the respective camera ray. The sampling scheme obtains information from the cells 430a-430h of the BEV plane that the respective camera ray of the plurality of camera rays 420. The obtained information may be aggregated using a weighted aggregator in a similar manner as described with reference to FIG. 4A. The respective values of wᵢ correspond to the orthogonal distance from the respective camera ray to the center of the respective intersecting cell 430a-430h.

FIG. 4D depicts a fourth visual representation 400D of an illustrative inverse view transform. Similar to the inverse view transform discussed with reference to FIG. 4A, the inverse view transform of FIG. 4D generates an image plane representation from the perspective of the position 402 and field of view 410 of the respective camera (e.g., one of the one or more cameras 302, 304, 306, 308). A plurality of camera rays 420 extending from the position 402 through respective pixels of the field of view 410 of the camera to the BEV plane 430 define portions of the BEV plane 430 where sampling of features from the encoded features in the BEV plane 430 should occur. As illustrated in the fourth visual representation 400D, the sampling scheme applied is not parameterized but the sampling weights may be defined by bilinear sampling scheme.

Accordingly, FIGS. 4A to 4D each depict a variation of the sampling scheme applied to extract encoded features from the BEV plane and transform them into an image plane representation of the environment for the respective image captured by the one or more cameras 302, 304, 306, 308.

### Example Operations

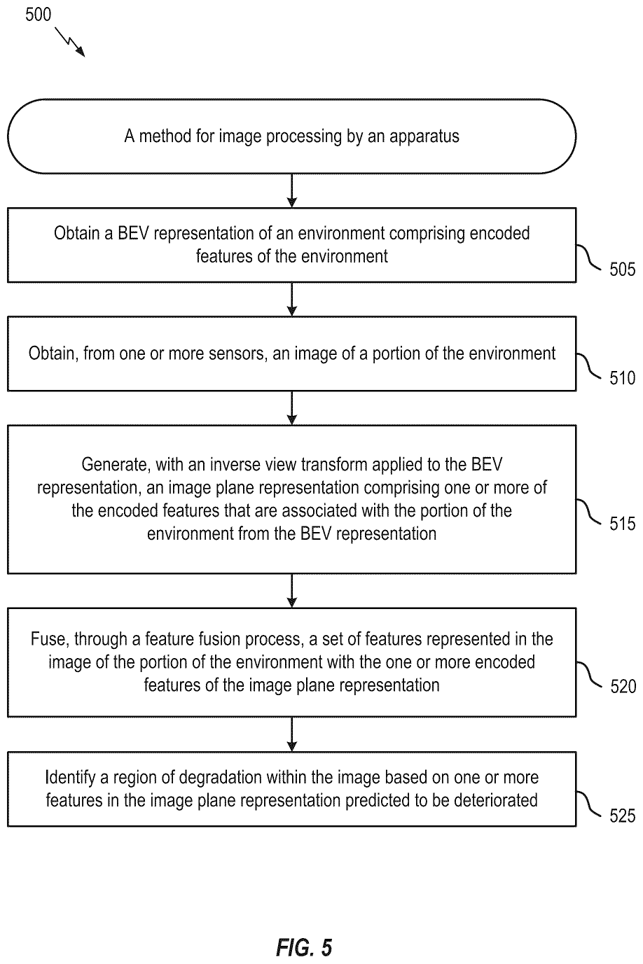

FIG. 5 shows an example method 500. Method 500 includes sensor performance assessment technique(s). In certain aspects, the method 500 leverages a BEV representation to assess sensors performance. Detecting whether an image from a sensor is degraded, can assure that degraded performance of the sensor will not negatively impact the functionality of advanced driving systems of the vehicle, for example.

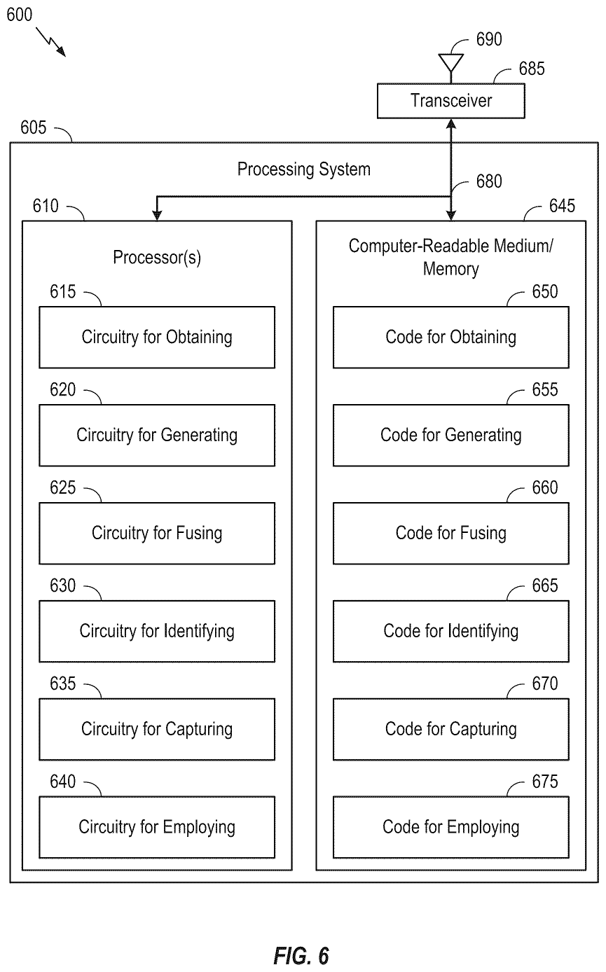

Aspects of the method 500 can be implemented by the computing device 240 comprising one or more processors 242 and a non-transitory computer readable memory 244 shown for example in FIG. 2 and/or the apparatus 600 of FIG. 6.

Method 500 begins at block 505 with obtaining a BEV representation of an environment comprising encoded features of the environment. For example, block 505 may include generating a BEV representation of the environment as described with reference to the BEV representation portion 310 of FIG. 3.

Method 500 then proceeds to block 510 with obtaining, from one or more sensors, an image of a portion of the environment. For example, block 510 may include obtaining one or more images from the one or more cameras 302, 304, 306, or 308 as described with reference to FIG. 3.

Method 500 then proceeds to block 515 with generating, with an inverse view transform applied to the BEV representation, an image plane representation comprising one or more of the encoded features that are associated with the portion of the environment from the BEV representation. For example, block 515 be implemented by the sensor performance assessment portion 340, as described with reference to FIG. 3.

Method 500 then proceeds to block 520 with fusing, through a feature fusion process, a set of features represented in the image of the portion of the environment with the one or more encoded features of the image plane representation. For example, block 520 may include the processes of the one or more feature fusion blocks 362, 364, 366, or 368 as described with reference to FIG. 3.

Method 500 then proceeds to block 525 with identifying a region of degradation within the image based on one or more features in the image plane representation predicted to be deteriorated. In certain aspects, block 525 may be implemented by the sensor performance assessment portion 340, as described with reference to FIG. 3.

In some aspects, method 500 further includes obtaining the BEV representation from another apparatus.

In some aspects, method 500 further includes generating the set of features from the image of the portion of the environment.

In some aspects, the feature fusion process comprises a feature-wise concatenation of the encoded features of the image plane representation and the set of features of the image.

In some aspects, the feature fusion process comprises a cross-attention process configured to fuse the set of features represented in the image of the portion of the environment with the one or more encoded features of the image plane representation.

In some aspects, method 500 further includes capturing, via the one or more sensors, image data to form the BEV representation at a first time period and capture the image of the portion of the environment at a second time period.

In some aspects, method 500 further includes capturing, via one or more second sensors, image data to form the BEV representation.

In some aspects, the one or more sensors comprise a multi-modal array of sensors configured to obtain multi-modal data of the portion of the environment.

In some aspects, an occlusion of the one or more features in the image comprises at least one of a presence of a glare in the image or a blockage on the one or more sensors.

In some aspects, block 515 includes obtaining an aggregation of 3D features defined by the BEV representation based on a ray extending through a reference image plane representation and each of the 3D features, wherein the reference image plane representation corresponds to a field of view of the image.

In some aspects, block 515 includes employing a dense query-based transformer configured to extract spatial features from regions of the BEV representation based on a reference image plane representation corresponding to a field of view of the image.

In some aspects, block 515 includes employing inverse bilinear sampling of the BEV representation based on a reference image plane representation corresponding to a field of view of the image.

In some aspects, the one or more sensors comprise one or more cameras.

In some aspects, method 500, or any aspect related to it, may be performed by an apparatus, such as apparatus 600 of FIG. 6, which includes various components operable, configured, or adapted to perform the method 500. Apparatus 600 is described below in further detail.

Note that FIG. 5 is just one example of a method, and other methods including fewer, additional, or alternative operations are possible consistent with this disclosure.

### Example Apparatus

FIG. 6 depicts aspects of an example apparatus 600 configured for sensor performance assessment techniques. In some aspects, apparatus 600 is may be the computing device 240 comprising one or more processors 242 and a non-transitory computer readable memory 244 shown for example in FIG. 2. In certain aspects, the apparatus 600 may be a vehicle or other device as discussed herein.

The apparatus 600 includes a processing system 605 coupled to a transceiver 685 (e.g., a transmitter and/or a receiver). The transceiver 685 is configured to transmit and receive signals for the apparatus 600 via an antenna 690, such as the various signals as described herein. The processing system 605 may be configured to perform processing functions for the apparatus 600, including processing signals received and/or to be transmitted by the apparatus 600.

The processing system 605 includes one or more processors 610 and a computer-readable medium/memory 645. In various aspects, the one or more processors 610 may be representative of the one or more processors of a computing device. The one or more processors 610 are coupled to a computer-readable medium/memory 645 via a bus 680. In some aspects, the computer-readable medium/memory 645 may be representative of the one or more memories (e.g., the non-transitory computer readable memory 244 described with respect to FIG. 2). The computer-readable medium/memory 645 is a non-transitory computer-readable medium/memory. In certain aspects, the computer-readable medium/memory 645 is configured to store instructions (e.g., computer-executable code), that when executed by the one or more processors 610, cause the one or more processors 610 to perform the method 500 described with respect to FIG. 5, or any aspect related to it, including any operations described in relation to FIG. 5. Note that reference to a processor performing a function of apparatus 600 may include one or more processors performing that function of apparatus 600, such as in a distributed fashion.

In the depicted example, computer-readable medium/memory 645 stores code (e.g., executable instructions), including code for obtaining 650, code for generating 655, code for fusing 660, code for identifying 665, code for capturing 670, and code for employing 675. Processing of the code 650-675 may enable and cause the apparatus 600 to perform the method 500 described with respect to FIG. 5, or any aspect related to it.

The one or more processors 610 include circuitry configured to implement (e.g., execute) the code stored in the computer-readable medium/memory 645, including circuitry for obtaining 615, circuitry for generating 620, circuitry for fusing 625, circuitry for identifying 630, circuitry for capturing 635, and circuitry for employing 640. Processing with circuitry 615-640 may enable and cause the apparatus 600 to perform the method 500 described with respect to FIG. 5, or any aspect related to it.

More generally, means for communicating, transmitting, sending or outputting for transmission may include the one or more transceivers 685, one or more antennas 690 of the apparatus 600 in FIG. 6, and/or one or more processors 610 of the apparatus 600 in FIG. 6. Means for communicating, receiving or obtaining may include the one or more transceivers 685, one or more antennas 690 of the apparatus 600 in FIG. 6, and/or one or more processors 610 of the apparatus 600 in FIG. 6.

### Example Clauses

Implementation examples are described in the following numbered clauses:
Clause 1: A method comprising: obtaining a BEV representation of an environment comprising encoded features of the environment; obtaining, from one or more sensors, an image of a portion of the environment; generating, with an inverse view transform applied to the BEV representation, an image plane representation comprising one or more of the encoded features that are associated with the portion of the environment from the BEV representation; fusing, through a feature fusion process, a set of features represented in the image of the portion of the environment with the one or more encoded features of the image plane representation; and identifying a region of degradation within the image based on one or more features in the image plane representation predicted to be deteriorated.
Clause 2: The method of Clause 1, further comprising obtaining the BEV representation from another apparatus.
Clause 3: The method of any one of Clauses 1-2, further comprising generating the set of features from the image of the portion of the environment.
Clause 4: The method of Clause 3, wherein the feature fusion process comprises a feature-wise concatenation of the encoded features of the image plane representation and the set of features of the image.
Clause 5: The method of any one of Clauses 1-3, wherein the feature fusion process comprises a cross-attention process configured to fuse the set of features represented in the image of the portion of the environment with the one or more encoded features of the image plane representation.
Clause 6: The method of any one of Clauses 1-3, wherein the feature fusion process comprises an element-wise addition process to fuse the set of features represented in the image of the portion of the environment with the one or more encoded features of the image plane representation.
Clause 7: The method of any one of Clauses 1-3, wherein the feature fusion process comprises an element-wise product process to fuse the set of features represented in the image of the portion of the environment with the one or more encoded features of the image plane representation.
Clause 8: The method of any one of Clauses 1-7, wherein the inverse view transform is configured to utilize weight values associated with a view transform process implemented to form the BEV representation.
Clause 9: The method of any one of Clauses 1-8, further comprising capturing, via the one or more sensors, image data to form the BEV representation at a first time period and capture the image of the portion of the environment at a second time period.
Clause 10: The method of any one of Clauses 1-9, further comprising capturing, via one or more second sensors, image data to form the BEV representation.
Clause 11: The method of any one of Clauses 1-10, wherein the one or more sensors comprise a multi-modal array of sensors configured to obtain multi-modal data of the portion of the environment.
Clause 12: The method of any one of Clauses 1-11, wherein an occlusion of the one or more features in the image comprises at least one of a presence of a glare in the image or a blockage on the one or more sensors.
Clause 13: The method of any one of Clauses 1-12, wherein generating, with the inverse view transform, the image plane representation comprises obtaining an aggregation of 3D features defined by the BEV representation based on a ray extending through a reference image plane representation and each of the 3D features, wherein the reference image plane representation corresponds to a field of view of the image.
Clause 14: The method of any one of Clauses 1-13, wherein generating, with the inverse view transform, the image plane representation comprises employing a dense query-based transformer configured to extract spatial features from regions of the BEV representation based on a reference image plane representation corresponding to a field of view of the image.
Clause 15: The method of any one of Clauses 1-14, wherein generating, with the inverse view transform, the image plane representation comprises employing inverse bilinear sampling of the BEV representation based on a reference image plane representation corresponding to a field of view of the image.
Clause 16: The method of any one of Clauses 1-15, wherein the one or more sensors comprise one or more cameras.
Clause 17: One or more apparatuses, comprising: one or more memories comprising executable instructions; and one or more processors configured to execute the executable instructions and cause the one or more apparatuses to perform a method in accordance with any one of Clauses 1-16.
Clause 18: One or more apparatuses configured for sensor performance assessment, comprising: one or more memories; and one or more processors, coupled to the one or more memories, configured to cause the one or more apparatuses to perform a method in accordance with any one of Clauses 1-16.
Clause 19: One or more apparatuses configured for sensor performance assessment, comprising: one or more memories; and one or more processors, coupled to the one or more memories, configured to perform a method in accordance with any one of Clauses 1-16.
Clause 20: One or more apparatuses, comprising means for performing a method in accordance with any one of Clauses 1-16.
Clause 21: One or more non-transitory computer-readable media comprising executable instructions that, when executed by one or more processors of one or more apparatuses, cause the one or more apparatuses to perform a method in accordance with any one of Clauses 1-16.
Clause 22: One or more computer program products embodied on one or more computer-readable storage media comprising code for performing a method in accordance with any one of Clauses 1-16.
Clause 23: One or more apparatuses configured for sensor performance assessment, comprising: a processing system that includes one or more processors and one or more memories coupled with the one or more processors, the processing system configured to cause the one or more apparatuses to perform a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising: a processing system that includes one or more processors and one or more memories coupled with the one or more processors, the processing system configured to cause the apparatus to:
obtain a bird's eye view (BEV) representation of an environment comprising encoded features of the environment;
obtain, from one or more sensors, an image of a portion of the environment;
generate, with an inverse view transform applied to the BEV representation, an image plane representation comprising one or more of the encoded features that are associated with the portion of the environment from the BEV representation;
fuse, through a feature fusion process, a set of features represented in the image of the portion of the environment with the one or more encoded features of the image plane representation; and
identify a region of degradation within the image based on one or more features in the image plane representation predicted to be deteriorated.

2. The apparatus of claim 1, wherein the processing system is configured to cause the apparatus to obtain the BEV representation from another apparatus.

3. The apparatus of claim 1, wherein the processing system is configured to cause the apparatus to generate the set of features from the image of the portion of the environment.

4. The apparatus of claim 3, wherein the feature fusion process comprises a feature-wise concatenation of the encoded features of the image plane representation and the set of features of the image.

5. The apparatus of claim 3, wherein the feature fusion process comprises a cross-attention process configured to fuse the set of features represented in the image of the portion of the environment with the one or more encoded features of the image plane representation.

6. The apparatus of claim 3, wherein the feature fusion process comprises an element-wise addition process to fuse the set of features represented in the image of the portion of the environment with the one or more encoded features of the image plane representation.

7. The apparatus of claim 3, wherein the feature fusion process comprises an element-wise product process to fuse the set of features represented in the image of the portion of the environment with the one or more encoded features of the image plane representation.

8. The apparatus of claim 1, wherein the inverse view transform is configured to utilize weight values associated with a view transform process implemented to form the BEV representation.

9. The apparatus of claim 1, wherein the processing system is configured to cause the apparatus to capture, via the one or more sensors, image data to form the BEV representation at a first time period and capture the image of the portion of the environment at a second time period.

10. The apparatus of claim 1, wherein the processing system is configured to cause the apparatus to capture, via one or more second sensors, image data to form the BEV representation.

11. The apparatus of claim 1, wherein the one or more sensors comprise a multi-modal array of sensors configured to obtain multi-modal data of the portion of the environment.

12. The apparatus of claim 1, wherein an occlusion of the one or more features in the image comprises at least one of a presence of a glare in the image or a blockage on the one or more sensors.

13. The apparatus of claim 1, wherein to generate, with the inverse view transform, the image plane representation, the processing system is configured to cause the apparatus to obtain an aggregation of 3D features defined by the BEV representation based on a ray extending through a reference image plane representation and each of the 3D features, wherein the reference image plane representation corresponds to a field of view of the image.

14. The apparatus of claim 1, wherein to generate, with the inverse view transform, the image plane representation, the processing system is configured to cause the apparatus to employ a dense query-based transformer configured to extract spatial features from regions of the BEV representation based on a reference image plane representation corresponding to a field of view of the image.

15. The apparatus of claim 1, wherein to generate, with the inverse view transform, the image plane representation, the processing system is configured to cause the apparatus to employ inverse bilinear sampling of the BEV representation based on a reference image plane representation corresponding to a field of view of the image.

16. The apparatus of claim 1, wherein the one or more sensors comprise one or more cameras.

17. A method comprising:
obtaining a bird's eye view (BEV) representation of an environment comprising encoded features of the environment;
obtaining, from one or more sensors, an image of a portion of the environment;
generating, with an inverse view transform applied to the BEV representation, an image plane representation comprising one or more of the encoded features that are associated with the portion of the environment from the BEV representation;
fusing, through a feature fusion process, a set of features represented in the image of the portion of the environment with the one or more encoded features of the image plane representation; and
identifying a region of degradation within the image based on one or more features in the image plane representation predicted to be deteriorated.

18. The method of claim 17, further comprising obtaining the BEV representation from another apparatus.

19. The method of claim 17, further comprising generating the set of features from the image of the portion of the environment.

20. A system, comprising:
one or more cameras configured to capture images of portions of an environment;
a processing system that includes one or more processors and one or more memories coupled with the one or more processors, the processing system configured to cause the system to:
obtain a bird's eye view (BEV) representation of the environment comprising encoded features of the environment;
obtain, from the one or more cameras, an image of a portion of the environment;
generate, with an inverse view transform applied to the BEV representation, an image plane representation comprising one or more of the encoded features that are associated with the portion of the environment from the BEV representation;
fuse, through a feature fusion process, a set of features represented in the image of the portion of the environment with the one or more encoded features of the image plane representation; and
identify a region of degradation within the image based on one or more features in the image plane representation predicted to be deteriorated.
